(19) United States
(12) Patent Application Publication
(10) Pub. No.: US 2010/0114803 A1
(43) Pub. Date: May 6, 2010

(54) APPARATUS AND METHOD FOR MODELING USER'S SERVICE USE PATTERN

(76) Inventors: Ae-kyeung MOON, Daejeon-si (KR); Young-il CHOI, Daejeon-si (KR); Byung-sun LEE, Daejeon-si (KR)

Correspondence Address: LADAS & PARRY LLP, 224 SOUTH MICHIGAN AVENUE, SUITE 1600, CHICAGO, IL, 60604, US

(21) Appl. No.: 12/497,731

(22) Filed: Jul. 6, 2009

(30) Foreign Application Priority Data
Oct. 30, 2008 (KR) 10-2008-0107149

(51) Int. Cl. G06F 15/18; G06F 17/30

(52) U.S. Cl. 706/12; 707/E17.009

(57) ABSTRACT

Provided are an apparatus and method for learning and modeling a user's service use pattern. The method includes: collecting information about a service selected by the user and situation information of the user when selecting the service; learning the user's service use pattern based on the collected information; and updating a learning value of a corresponding context-service pair in a user model, which is comprised of context-service pairs, based on the learning result, wherein the situation information of the user includes one or more contexts.

### CROSS-REFERENCE TO RELATED APPLICATION

This application claims the benefit under 35 U.S.C. §119(a) of Korean Patent Application No. 10-2008-107149, filed on Oct. 30, 2008, the disclosure of which is incorporated by reference in its entirety for all purposes.

### BACKGROUND

1. Field

The following description relates to a technology that can provide a personalized service, and more particularly, to a technology that can provide a personalized service based on situation recognition.

2. Description of the Related Art

The development of information technology (IT) and the increased use of the Internet have resulted in an exponential increase of information available to users. However, this exponential increase of information presents users with the challenge of searching through a vast amount of information to find and select desired information. To address this problem, research is being performed into content recommendation systems which can provide a service personalized to a user by filtering out information that is not desired by the user and by recommending useful information. Conventional research has been focused on recommending contents by utilizing user profile information according to the clear needs of each user. That is, conventional research is based on the assumption that refined information can be received from the user in a static environment such as customer relationship management (CRM) environment.

Conventional personalization techniques that are widely used include content-based techniques and collaborative filtering techniques, and most of these techniques require prior information about users or detailed information about items the user would consider as recommended items. However, meta information of services provided by service providers is not fully defined, and it is difficult to collect, in advance, information about users due to security or privacy matters. Therefore, using the conventional techniques, provision of personalized services can be very limited.

### SUMMARY

The following description relates to an apparatus and method for modeling a user's service use pattern, the apparatus and method capable of providing personalized content service to a user without requiring prior information about the user or detailed information about items the user would consider as recommended items.

According to an exemplary aspect, there is provided an apparatus for modeling a user's service use pattern. The apparatus includes: a user model database storing a user model which is composed of context-service pairs and records a learning value of each of the context-service pairs; a service information collection unit collecting information about a service selected by the user; a situation information collection unit collecting situation information of the user when selecting the service; and a learning unit learning the user's service use pattern based on the information about the service selected by the user and the situation information of the user and updating learning values of one or more corresponding context-service pairs, wherein the situation information of the user includes one or more contexts.

The apparatus further includes a recommendation unit creating a service prediction table, which comprises services that the user is expected to use in a current situation of the user, based on the user model and the situation information collected by the situation information collection unit and recommending a service based on the created service prediction table.

According to another exemplary aspect, there is provided a method of modeling a user's service use pattern. The method includes: collecting information about a service selected by the user and situation information of the user when selecting the service; learning the user's service use pattern based on the collected information; and updating a learning value of a corresponding context-service pair in a user model, which is composed of context-service pairs, based on the learning result, wherein the situation information of the user includes one or more contexts.

The method further includes determining a domain based on the collected situation information before the learning of the user's service use pattern, wherein in the updating of the learning value, the learning value of the corresponding context-service pair is updated using a reward defined in a context profile which corresponds to the determined domain.

The method further includes: creating a service prediction table, which comprises services that the user is expected to use in a current situation of the user, based on the user model and the situation information of the user; and recommending a service based on the created service prediction table.

The method further includes: receiving feedback on whether the user used the recommended service; and updating the learning value of the corresponding context-service pair in the user model based on the feedback result.

Other objects, features and advantages will be apparent from the following description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain aspects of the invention.

FIG. 1 illustrates the configuration of a system for modeling service use patterns of users according to an exemplary embodiment;

FIG. 2 illustrates the structure of a context profile used to learn a user model;

FIG. 3 illustrates an exemplary context profile;

FIG. 4 is a flowchart illustrating a method of creating and learning a user model;

FIG. 5 is a flowchart illustrating a method of recommending a user service;

FIG. 6 is a flowchart illustrating a method of learning based on feedback regarding a recommended service; and

FIG. 7 is a block diagram of the modeling server 100 illustrated in FIG. 1.

### DETAILED DESCRIPTION

The invention is described more fully hereinafter with reference to the accompanying is drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art.

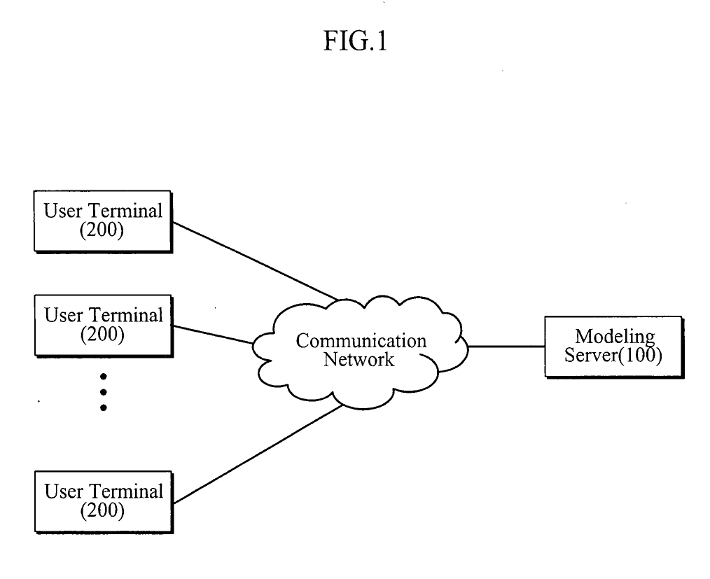

FIG. 1 illustrates the configuration of a system for modeling service use patterns of users according to an exemplary embodiment.

Referring to FIG. 1, an apparatus for modeling service use patterns of users (hereinafter, referred to as a ‘modeling server’ 100) can communicate with a plurality of user terminals 200 over a network. In one exemplary embodiment, the communication between the modeling server 100 and the user terminal 200 is based on, but not limited to, a transport control protocol/Internet protocol (TCP/IP) or a user datagram protocol (UDP). The modeling server 100 models a service use pattern of users. Specifically, the modeling server 100 receives, from the user terminal 200, information about a service selected by a user of the user terminal 200 and information about the situation of the user when selecting the service. Then, the modeling server 100 learns the user's service use pattern from the received information and, based on the learning result, recommends a service suitable for the current situation of the user to the user terminal 200.

The user terminal 200 may be a mobile phone, a personal digital assistant (PDA), or any other type of communication equipment. For communication with the modeling server 100, an application program is installed on the user terminal 200. The application program transmits information about the current situation (described in the following paragraph in more detail) of the user and information about a service selected by the user to the modeling server 100 over a network. Then, the modeling server 100 recommends at least one service suitable for the current situation of the user. Accordingly, the application program informs the user of the service recommended by the modeling server 100.

More specifically, the application program installed on the user terminal 200 obtains information about a service (such as watching digital multimedia broadcasting (DMB), listening to the radio, MP3 playback, or Internet access) selected by the user and information regarding the current situation (hereinafter referred to as situation information) of the user when selecting the service. Here, the situation information of the user is information about the current environment of the user, such as the user's location, the user's activity, and current time. In a house, for example, a noise sensor, a radio-frequency identification (RFID) sensor, a biosensor, and physical environment sensors for measuring temperature and humidity may be installed, and the user terminal 200 may obtain the situation information of the user from the above sensors.

As described above, the application program of the user terminal 200 obtains information about a service selected by the user and the situation information of the user when selecting the service and transmits the obtained information to the modeling server 100. Then, the user terminal 200 displays a service recommended by the modeling server 100 on the screen thereof to inform the user of the recommended service. If the user selects the recommended service, the user terminal 100 provides the service directly or receives the service from an external source in order to provide the service.

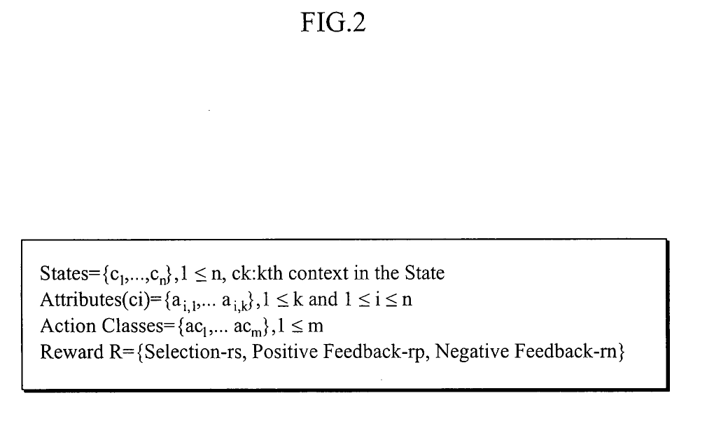

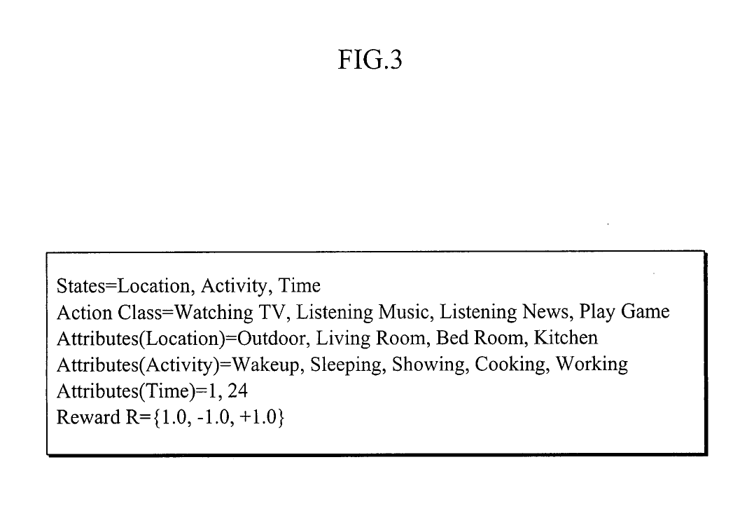

FIG. 2 illustrates the structure of a context profile used to learn a user model. FIG. 3 illustrates an exemplary context profile.

The modeling server 100 learns a user model which is composed of context-service pairs. Referring to FIGS. 2 and 3, “States” consists of contexts that can be obtained by the user terminal 200. To learn a user model, information about values of contexts is required. This information is defined as a context profile, and the content of a content profile is illustrated in FIG. 2. “Attributes (c₁)” is an attribute value of a context cᵢ, and each attribute value may be a is discrete value or a continuous value. For example, there may be three contexts: activity, location, and time. In this case, attribute values of activity and location are discrete values, and time has a minimum value and a maximum value as its attribute value since it represents continuous data. Environment information such as temperature and humidity also has a continuous value as its attribute value. When an attribute value is a continuous value, a normalization process is required to map the continuous value to a discrete value.

“Reward” is a value that must be reflected in a user model based on the result of learning a user's service use pattern. Rewards are divided into a reward used when a user actively selects a service, a reward used when the user uses a recommended service, and a reward used when the user does not use the recommended service. The reward used when a user actively selects a service is defined as “Selection-rs,” the reward used when the user reacts positively to a recommended service is defined as “Positive Feedback-rp,” and the reward used when the user reacts negatively to the recommended service is defined as “Negative Feedback-rn.” Since a context profile may exist for each domain, rewards may be included in each context profile, so that different rewards can be set for each domain. Domains do not represent all environments. Instead, each domain models represents one of a number of groups into which various environments are categorized. Three domains, e.g., house, inside a car, and outdoor, may be modeled.

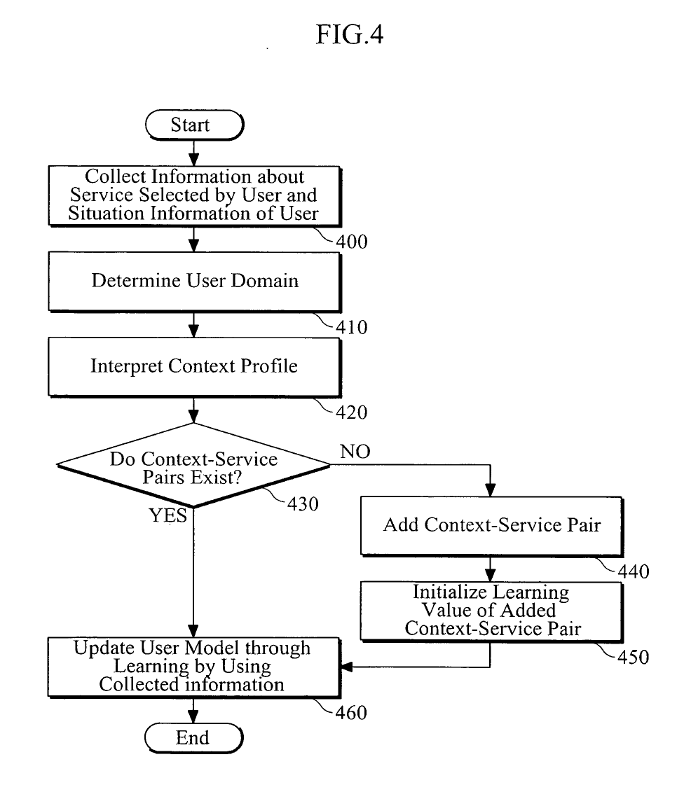

FIG. 4 is a flowchart illustrating a method of creating and learning a user model.

Referring to FIG. 4, the modeling server 100 collects information about a service selected by a user and situation information of the user when selecting the service (operation 400). Here, the situation information is composed of one or more contexts. The modeling server 100 determines a domain based on the collected situation information (operation 410). Then, the modeling server 100 interprets a context profile corresponding to the determined domain and determines whether all of context-service pairs defined in the interpreted context profile exist in a user model (operations S420 and S430). If some of the context-service pairs do not exist in the user model, the context-service pairs are created, and learning values of the created context-service pairs are initialized (operations S440 and S450). Operations S420 through S450 are performed since different contexts and services may be defined in each context file. If only one domain exists, there is no need to determine a domain. In this case, only one context profile, which is initially and uniquely provided, is interpreted, and a situation recognition user model (C-TBL), which includes context-service pairs, is created based on the interpreted context profile. Thus, there is no need to additionally configure context-service pairs.

A user model (C-TBL) includes context-service pairs. When the situation information includes three contexts, e.g., activity, location, and time, if a location-service pair already exists in another context profile, it is not created again. That is, only context-service pairs that do not exist in the user model are added to the user model. Then, the user model is updated according to the service clearly requested by the user (operation 460).

For example, if a user wakes up (c2: Wakeup) at seven o'clock in the morning (c3) and requests a news service (ac1: ListeningNews) in the bedroom (c1: Bedroom), the modeling server 100 updates a user model using a reward (Selection-rs) defined in a corresponding context profile. That is, learning values of C-TBL[c1][ac1] and C-TBL[c2][ac1] are updated. As for time information, a learning value of C-TBL[c3][ac1] is updated after the normalization process. This updating process is defined by the following equation:

for each cᵢ in C-TBL[aᵢ, k(t)][ac(t)] do

C-TBL[aᵢ, k][ac(t)]←C-TBL[aᵢ, k(t)][ac(t)]+γR(t),

where γ is the discount factor and cᵢ∈State.

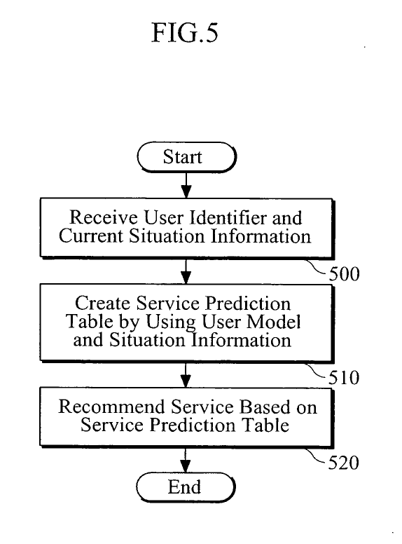

FIG. 5 is a flowchart illustrating a method of recommending a user service.

Referring to FIG. 5, the modeling server 100 receives a user identifier and current situation information regarding a user from the user terminal 200 (operation 500). To recommend a personalized service to the user, the modeling server 100 creates a service prediction table (P-TBL) suitable for the current situation of the user by using a user model (C-TBL) (operation 510). The service prediction table (P-TBL) contains preferred action information for each context included in the situation information of the user. If aᵢ∈Attributes(cᵢ) and “cs” indicates current situation, cᵢ∈cs. The service prediction table (P-TBL) may be calculated by the following equation:

$$P \text{-} TBL [ a {c}_{k} ] = M ( cs ) {\sum }_{{a}_{i} ∈ cs} {w}_{i} \times C \text{-} TBL [ {a}_{i} ] [ a {c}_{k} ]$$

, where M(cs) is used to normalize each value to be in the range of 0 to 1 when the service prediction table (P-TBL) is created using the user model (C-TBL), and wᵢ is a weight given to a context cᵢ for each user. In general, the weight wᵢ is a fixed value. However, entropy of each context is calculated in order to give a different weight to each context according to characteristics of users. The entropy of each context provides an information gain needed to select a service. In the following equation, p(I) indicates a ratio of the number of entities (?) included in ActionClass I to the total number of entities in the entropy “S”.

$$Entropy ( S ) = {\sum }_{I ∈ ActionClass} [ - p ( I ) {log}_{2} p ( I ) ]$$

For example, when the entropy “S” includes two classes of ac₁ and ac₂, a ratio of the number of entities included in ac₁ to the total number of entities may be p(ac₁), and a ratio of the number of entities included in ac₂ to the total number of entities may be p(ac₂). In this case, the entropy of a context may be calculated by −p(ac₁)log₂(p(ac₁))−p(ac₂)log₂(p(ac₂)). Using the calculated entropy of the context, an information gain for the context is calculated. In the following equation, gain(cₖ) indicates an information gain for a context cₖ, and Sᵥ indicates a value of each attribute that the context cₖ can have. The calculated information gain of each context is applied to the weight wᵢ thereof. When there are many contexts, the contexts may be prioritized based on the calculated information gains, and a context which affects the selection of a service may be selected.

$${w}_{k} \approx Gain ( {C}_{k} ) = Entropy ( S ) - {\sum }_{v ∈ Attributes ( {c}_{k} )} [ ( \vert {S}_{v} \vert / \vert S \vert ) Entropy ( {S}_{v} )$$

P-TBL[acₖ] for the current situation of the user is calculated by applying the weight wᵢ of each context, and a service corresponding to P-TBL[acₖ] having a highest value is recommended, or a list of recommended services corresponding respectively to a plurality of P-TBL[acₖ], which are prioritized in order of highest to lowest value, are provided to the user terminal (operation 520).

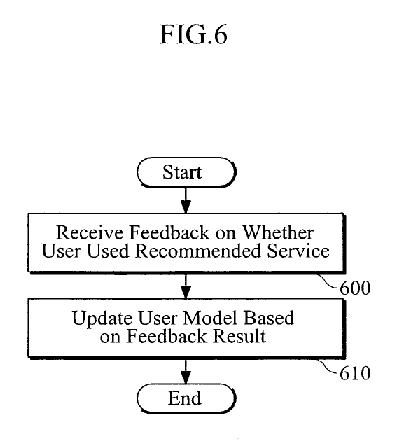

FIG. 6 is a flowchart illustrating a method of learning based on feedback regarding a recommended service.

Referring to FIG. 6, the modeling server 100 receives feedback on whether a user selected or refused a service recommended using the method of FIG. 5 (operation 600). Then, the modeling server 100 learns the feedback and updates a user model accordingly (operation 610). That is, the modeling server 100 updates the user model using a reward (Positive Feedback-rp or Negative Feedback-rn) defined in a corresponding context profile. For example, if the user used the recommended service, the modeling server 100 may update the user model using a value of Positive Feedback-rp. If not, the modeling server 100 may update the user model using a value of Negative Feedback-rn.

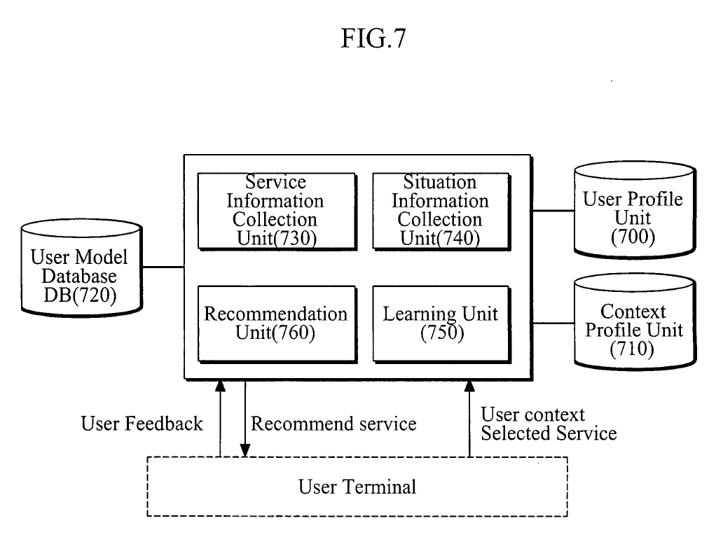

FIG. 7 is a block diagram of the modeling server 100 illustrated in FIG. 1.

Referring to FIG. 7, a user profile unit 700 stores user profiles, each containing specific pieces of information about a user, such as occupation, age, gender, and a user identifier. Each of the user profiles may further contain importance of each context that a user takes into consideration when selecting a service, that is, information indicating a weight of each context.

A context profile unit 710 stores one or more context profiles. As illustrated in FIG. 2, a context profile defines a plurality of contexts representing a situation, an attribute of each context, and a plurality of services. If a different context profile is created for each domain, the context profile unit 710 stores a plurality of context profiles which respectively correspond to domains.

A service information collection unit 730 collects information about a service selected by a user, and a situation information collection unit 740 collects situation information of the user. When a user selects a service, the user terminal 200 may transmit information about the service selected by the user and situation information of the user to the modeling server 100. Accordingly, the modeling server 100 may simultaneously collect the information about the service selected by the user and the situation information synchronized with the information about the selected service. Alternatively, the modeling server 100 may continuously monitor the user terminal 200 to identify the situation of the user when selecting a service.

A user model database 720 stores a user model (C-TBL) for each user. A user model includes context-service pairs, and a learning value is reflected in each of the context-service pairs. For example, a user model may include a location-service pair, an activity-service pair, and a time-service pair. In this case, a learning value resulting from the learning operation of a learning unit 750 is reflected in each of the pairs.

The learning unit 750 learns the service information collected by the service information collection unit 730 and the state information collected by the situation information collection unit 740. The learning unit 750 determines a domain based on one or more contexts that are included in the situation information. Then, the learning unit 750 learns a user's service use pattern with reference to a context profile corresponding to the determined domain. Based on the result of learning the user's service use pattern, the learning unit 750 updates a learning value of a corresponding context-service pair in a user model by using a reward stored in the context profile.

When the result of learning the service use pattern of a user, who is managed using a user model, exceeds a predetermined level at which it is determined that the service use pattern of the user has been fully learned, a recommendation unit 760 identifies a service frequently used by the user in the current situation and recommends the service to the user. Specifically, the recommendation unit 760 creates a service prediction table (P-TBL) by using the user model and recommends a service based on the created service prediction table. The service prediction table may be created by reflecting the weight of each context. Here, the weight of each context may be calculated as described above. Alternatively, the recommendation unit 760 may create a service prediction table by reflecting the weight of each context stored in the user profile unit 700.

Once a service is recommended, the learning unit 750 receives feedback on whether the user used the recommended service and learns the feedback. As described above, the learning unit 750 updates the user model using a reward (Positive Feedback-rp or Negative Feedback-rn) defined in the context profile according to whether the user used the recommended service.

In the above example, a case where the user terminal 200 collects all situation information and provides the collected situation information to the modeling server 100 has been described. However, the modeling server 100 may also obtain situation information of the user terminal 200 from external sensors in an ubiquitous environment while still receiving situation information that can be collected by the user terminal 200 from the user terminal 200.

The present invention makes it possible to actively and accurately provide a personalized service to a user by learning the user's service use pattern through interactions with the user. At a learning stage, a user's service use pattern is learned. Flexibility is allowed in situation information. That is, situation information is composed of contexts (such as time and location) extracted from sensors which are installed in a user's environment. In addition, the concept of domains into which various environments are grouped is introduced. Thus, a context profile is created for each domain, and a user has two-dimensional (context-service pair) information for each domain. For service recommendation, a domain is determined first. Then, a set of contexts that can be accessed in the determined domain are extracted, and a service is recommended based on a subset of the set of contexts. That is, a user model can be configured using pairs of currently accessible contexts and their corresponding services through a learning process. Hence, the situation information is not limited to information about a specified environment. That is, contexts can be easily added or removed from the situation information. In this regard, when service recommendation is required, a service can be recommended based only on accessible situation information.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An apparatus for modeling a user's service use pattern, the apparatus comprising:
a user model database storing a user model which is comprised of context-service pairs and records a learning value of each of the context-service pairs;
a service information collection unit collecting information about a service selected by the user;
a situation information collection unit collecting situation information of the user; and
a learning unit learning the user's service use pattern based on the information about the service selected by the user and the situation information of the user and updating learning values of one or more corresponding context-service pairs;
wherein the situation information of the user comprises one or more contexts.

2. The apparatus of claim 1, wherein at least one of the contexts of the situation information is location, time, or activity.

3. The apparatus of claim 1, further comprising a context profile unit storing a context profile which defines a plurality of contexts, an attribute of each context, and a plurality of services, wherein the learning unit creates the user model based on the context profile stored in the context profile unit and updates learning values of one or more corresponding context-service pairs based on the result of learning the user's service use pattern.

4. The apparatus of claim 3, wherein the context profile unit stores a context profile corresponding to each domain, and the learning unit determines a domain based on the situation information of the user and uses a context profile corresponding to the determined domain.

5. The apparatus of claim 1, further comprising a recommendation unit creating a service prediction table, which comprises services that the user is expected to use in a current situation of the user, based on the user model and the situation information collected by the situation information collection unit and recommending a service based on the created service prediction table.

6. The apparatus of claim 5, wherein the recommendation unit adds learning values for all contexts included in the situation information of the user for each service and creates a service prediction table which shows the addition result.

7. The apparatus of claim 6, wherein the recommendation unit assigns a different weight to each context included in the situation information of the user, reflects the weight in the learning value of each context-service pair, and creates a service prediction table.

8. The apparatus of claim 7, wherein the recommendation unit calculates a gain, which represents the weight of each context, by using the user model and reflects the calculated gain of each context in the learning value of a corresponding context-service pair as the weight of each context included in the situation information of the user.

9. The apparatus of claim 7, further comprising a user profile unit storing information about the weight of each context for each user, wherein the recommendation unit reflects the weight of each context stored in the user profile unit in the learning value of a corresponding context-service pair.

10. The apparatus of claim 9, wherein the information about the weight of each context stored in the user profile unit is stored for each service.

11. The apparatus of claim 5, wherein the learning unit learns whether the user used the recommended service and reflects the learning result in the user model.

12. The apparatus of claim 11, wherein the learning unit updates a corresponding learning value in the user model by using a first reward when the user actively selects a service, a second reward when the user reacts positively to a recommended service, and a third reward when the user reacts negatively to the recommended service.

13. The apparatus of claim 11, further comprising a context profile unit storing a context profile which corresponds to each domain and defines a plurality of contexts, an attribute of each context, a plurality of services, and one or more rewards used to update one or more learning values in the user model, wherein the learning unit determines a domain based on the situation information of the user, creates the user model based on a context profile corresponding to the determined domain, and updates a learning value of a corresponding context-service pair by using a reward determined based on the learning result.

14. The apparatus of claim 13, wherein different rewards are set for each context profile which corresponds to a domain.

15. The apparatus of claim 13, wherein the rewards defined in the context profile comprise the first reward used when the user actively selects a service, the second reward used when the user reacts positively to a recommended service, and the third reward used when the user reacts negatively to the recommended service, and the learning unit updates the user model using the first reward when the user actively selects a service, the second reward when the user reacts positively to a recommended service, and the third reward when the user reacts negatively to the recommended service.

16. A method of modeling a user's service use pattern, the method comprising:
collecting information about a service selected by the user and situation information of the user when selecting the service;
learning the user's service use pattern based on the collected information; and
updating a learning value of a corresponding context-service pair in a user model, which is comprised of context-service pairs, based on the learning result,
wherein the situation information of the user comprises one or more contexts.

17. The method of claim 16, further comprising determining a domain based on the collected situation information before the learning of the user's service use pattern, wherein in the updating of the learning value, the learning value of the corresponding context-service pair is updated using a reward defined in a context profile which corresponds to the determined domain.

18. The method of claim 16, further comprising:
interpreting the context profile corresponding to the determined domain and identifying whether one or more context-service pairs defined in the context profile exist in the user model before the learning of the user's service use pattern is performed; and
adding a context-service pair to the user model when the context-service pair does not exist in the user model.

19. The method of claim 16, further comprising:
creating a service prediction table, which comprises services that the user is expected to use in a current situation of the user, based on the user model and the situation information of the user; and
recommending a service based on the created service prediction table.

20. The method of claim 19, further comprising:
receiving feedback on whether the user used the recommended service; and
updating the learning value of the corresponding context-service pair in the user model based on the feedback result.
